(19) United States
(12) Patent Application Publication
(10) Pub. No.: US 2026/0042419 A1
(43) Pub. Date: Feb. 12, 2026

(54) METHOD FOR LOCKING AND UNLOCKING A DOOR OF A MOTOR VEHICLE AND ASSOCIATED LOCKING AND UNLOCKING DEVICE

(71) Applicant: Continental Automotive Technologies GmbH, Hannover (DE)

(72) Inventors: Stéphane BILLY, Grenade (FR); Sylvain GODET, Villeneuve-lès-Bouloc (FR); Saïd BOUGUERN, Blagnac (FR)

(73) Assignee: Continental Automotive Technologies GmbH, Hannover (DE)

(21) Appl. No.: 19/101,355

(22) PCT Filed: Aug. 4, 2023
(86) PCT No.: PCT/EP2023/071711

§ 371 Date: Feb. 5, 2025

(30) Foreign Application Priority Data
Aug. 25, 2022 (FR) FR2208520

(51) Int. Cl. B60R 25/24; B60R 25/01; B60R 25/31

(52) U.S. Cl. CPC B60R 25/245; B60R 25/01; B60R 25/31

(57) ABSTRACT

A method for locking or unlocking a door of a vehicle, using a locking/unlocking device aboard the vehicle, including at least two high frequency communication transceivers capable of communicating with a portable user equipment, of which a first transceiver is located in the door and a second transceiver is located inside the vehicle. The method including: a) detecting the presence of the portable user equipment in a predetermined zone around the vehicle; b) if a portable equipment has been detected, transmitting waves between the two transceivers; c) measuring a time of flight of the waves; d) comparing the measured time of flight with a predetermined time of flight; and e) unlocking or locking the door according to the result of the comparison.

### CROSS REFERENCE TO RELATED APPLICATIONS

This application is the U.S. National Phase Application of PCT International Application No. PCT/EP2023/071711, filed Aug. 4, 2023, which claims priority to French Application No. 2208520, filed Aug. 25, 2022, the contents of such applications being incorporated by reference herein.

### FIELD OF THE INVENTION

The invention relates to a method for locking and unlocking a door of a motor vehicle. The invention applies more specifically to “hands-free” access to the vehicle.

### BACKGROUND OF THE INVENTION

Nowadays, vehicle door handles are equipped with “hands-free” locking/unlocking devices for a door. The detection of the approach of a user's hand toward the handle, coupled with the recognition of a “hands-free” electronic fob for remote controlled access, which fob is carried by this user, allows remote locking and unlocking of the opening elements of the vehicle. Thus, when the user, carrying the corresponding electronic fob identified by the vehicle, wishes to unlock the vehicle, they touch the door handle of the vehicle and the opening elements of the vehicle are then unlocked automatically. By approaching or by pressing on a precise location on the door handle of the vehicle, called “unlocking zone”, the door (or alternatively all of the opening elements) is (are) unlocked without any other action by the user. Conversely, when the user, still carrying the necessary fob identified by the vehicle, wishes to lock their vehicle, they close the door of their vehicle and press momentarily on another precise location of the handle, called “locking zone”. This gesture automatically locks the opening elements of the vehicle.

These locking/unlocking devices generally comprise two capacitive sensors, in the form of two electrodes that are electrically connected to a printed circuit and integrated in the door handle, each in a precise locking or unlocking zone. Generally, one electrode is dedicated to each zone, that is to say one electrode is dedicated to detecting the approach of and/or contact by the hand of the user in the locking zone and one electrode is dedicated to detecting the approach of and/or contact by the hand of the user in the unlocking zone.

The unlocking/locking device further comprises a radiofrequency antenna, for example using ultra-wideband (UWB), WiFi®, Bluetooth® or any other type of radiofrequency communication, including high and ultra-high frequency. The detection device is connected to the electronic computer of the vehicle (ECU: abbreviation for “Electronic Control Unit”) and sends it a presence detection signal. The electronic computer of the vehicle has previously identified the user as being authorized to access this vehicle, or alternatively it carries out this identification after receiving this presence detection signal. To this end, it uses the radiofrequency antenna to send an identification request to the fob (or remote control) carried by the user. This fob sends its identification code to the electronic computer of the vehicle in response, using radiofrequency waves. If the electronic computer recognizes the identification code as the one authorizing access to the vehicle, it triggers locking/unlocking of the door (or of all of the opening elements). However, if the electronic computer has not received an identification code, or if the received identification code is incorrect, locking or unlocking does not take place.

Such vehicles are therefore equipped with door handles comprising such a detection device, itself comprising a radiofrequency antenna, and two electrodes connected to a microcontroller that is integrated in a printed circuit and supplied with voltage.

However, this unlocking/locking device from the prior art exhibits major drawbacks.

In this instance, the detection of the approach of a user by the capacitive sensors is not robust and produces false detections.

In particular, in some environmental conditions, when raindrops or snowflakes come into contact with the door handle, these increase the capacitance value measured by the capacitive sensors, thus triggering false detections.

Moreover, the cost of the device is not negligible.

An aspect of the invention proposes a locking/unlocking method and device that overcome the drawbacks of the prior art.

### SUMMARY OF THE INVENTION

An aspect of the invention proposes a method for locking or unlocking a door of a vehicle, using a locking/unlocking device aboard the vehicle, comprising at least two high frequency communication transceivers capable of communicating with a portable user equipment, of which a first transceiver is located in the door and a second transceiver is located inside the vehicle, the method being remarkable in that it comprises the following steps:
a. detecting the presence of the portable user equipment in a predetermined zone around the vehicle,
b. if a portable equipment has been detected, transmitting waves between the two transceivers,
c. measuring a time of flight of said waves,
d. comparing said measured time of flight with a predetermined time of flight,
e. unlocking or locking the door according to the result of the comparison.

In a preferred embodiment of the method according to the invention, the door is previously equipped with two surfaces that are identifiable by the user, an unlocking surface and a locking surface, and:
a. when the user approaches the unlocking surface, the time of flight is greater than a first threshold, and
b. when the user approaches the locking surface, the time of flight is greater than a second threshold.

Advantageously, if the time of flight is greater than the first threshold then unlocking is activated, and if the time of flight is greater than the second threshold then locking is activated.

Conveniently, the predetermined time of flight has been previously measured in the absence of the portable equipment in the predetermined zone around the vehicle.

An aspect of the invention also applies to a device for locking or unlocking a door of a motor vehicle, which device is intended to be aboard said vehicle, comprising at least two high frequency communication transceivers capable of communicating with a portable user equipment, of which a first transceiver is located in the door and a second transceiver is located inside the vehicle, the device being characterized in that it is further capable of:
a. detecting the presence of the portable user equipment in a predetermined zone around the vehicle,
b. controlling the transmission of waves between the two transceivers on the basis of the detection,
c. measuring a time of flight of said waves,
d. comparing said measured time of flight with a predetermined time of flight,
e. unlocking or locking the door according to the result of the comparison.

According to the preferred embodiment of the invention, the device comprises two surfaces on the door that are identifiable by the user, an unlocking surface and a locking surface.

The device further comprises:
a. means for comparing the time of flight with a first threshold, and
b. means for comparing the time of flight with a second threshold, and it is capable of unlocking the door on the basis of a result of comparison with the first threshold and of locking the door on the basis of a result of comparison with the second threshold.

An aspect of the invention relates to any computer program product comprising program code instructions for executing the steps of the method according to any one of the features listed above when said program is executed on a computer.

Finally, an aspect of the invention applies to any motor vehicle comprising a locking or unlocking device according to any one of the features listed above.

### BRIEF DESCRIPTION OF THE DRAWINGS

Other features and advantages of aspects of the invention will become more clearly apparent on reading the description that follows. This description is purely illustrative and should be read with reference to the attached drawings, in which:

FIG. 1 schematically shows a motor vehicle equipped with the locking/unlocking device according to an aspect of the invention,

FIG. 2 schematically shows a vehicle door handle comprising an unlocking surface and a locking surface that are identifiable by the user according to an aspect of the invention,

FIG. 3 schematically shows the case of a hand of the user approaching the unlocking surface and the locking surface and its impact on the time of flight between the two transmitters compared to the case without a hand,

FIG. 4 illustrates a device according an aspect of to the invention,

FIG. 5 is a flowchart illustrating the locking/unlocking method according an aspect of to the invention, and

FIG. 6 is a graph showing the response of the time of flight between the two transceivers according to time t, in a first case, with the approach of the user's hand toward the unlocking surface, and in a second case, with the approach of the user's hand toward the locking surface.

### DETAILED DESCRIPTION OF PREFERRED EMBODIMENTS

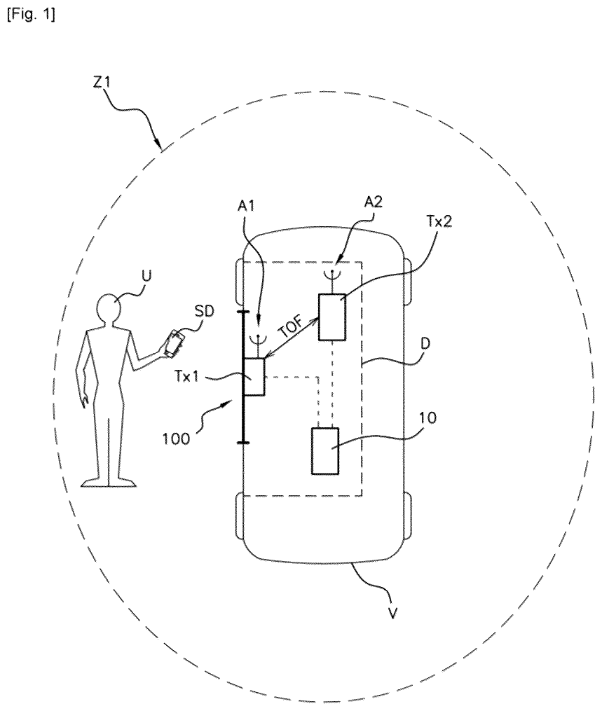

FIG. 1 shows a motor vehicle V equipped with the locking/unlocking device D according to an aspect of the invention.

The device D is equipped with at least two transceivers Tx1, Tx2, a first transceiver Tx1 of which is located in the driver's door, for example the front left door 100 of the motor vehicle, and a second transceiver Tx2 of which is located inside the vehicle V, for example in the passenger compartment. Each of transceivers Tx1, Tx2 are coupled to respective antennas A1, A2.

The implementation of an aspect of the invention requires each of the two transceivers not to be located close to an opening element of the vehicle V.

The transceivers Tx1, Tx2 are capable of conducting radiofrequency, for example high or ultra-high frequency, such as ultra-wideband (UWB), WiFi, or Bluetooth, communication with a portable user equipment SD, such as a portable smartphone SD. Thanks to this bidirectional communication between the transceivers Tx1, Tx2 and the portable access equipment SD, the device D is capable of knowing the position of said equipment SD with respect to the vehicle V and capable of also checking its identifier in order to ensure that it does indeed correspond to an identifier previously paired with the vehicle V. If the portable equipment SD is in a predetermined zone Z1 around the vehicle V and its identifier has been authenticated, then the opening elements of the vehicle V can be locked or unlocked according to the “hands-free” access procedure known to those skilled in the art.

An aspect of the invention will be described here using ultra-wideband communication. Ultra-wideband communication is a radio modulation technique that is based on transmitting pulses of very short duration, often less than one nanosecond, over a broad frequency spectrum. The bandwidth may thus reach very large values. UWB is generally considered to need to have a bandwidth-to-center-frequency ratio of at least 20%, or a bandwidth of 250 MHz or more.

The device D can thus detect the presence of the portable equipment SD in a predetermined zone Z1 around the vehicle, allowing “hands-free” locking/unlocking of the vehicle V.

According to an aspect of the invention, the device D is also capable, if the portable equipment SD has been detected in the predetermined zone Z1, of:
a. controlling the transmission of high frequency waves between the two transceivers Tx1, Tx2,
b. measuring a time of flight TOF1, TOF2 of said waves between the two transceivers Tx1, Tx2,
c. comparing said measured time of flight TOF1, TOF2 with a predetermined time of flight TOF,
d. unlocking or locking the door according to the result of the comparison.

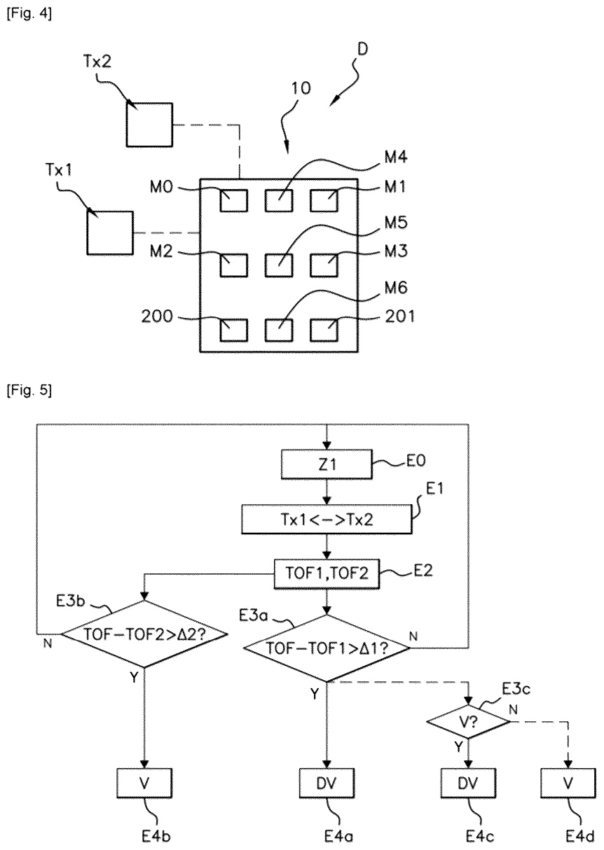

To this end, as shown in FIG. 4, the device D comprises:
a. means M0 for detecting the presence of the portable equipment SD in the predetermined zone Z1,
b. means M1 for controlling the transmission of high frequency waves between the two transceivers Tx1, Tx2,
c. means M2 for measuring the time of flight TOF1, TOF2 between the two transceivers Tx1, Tx2,
d. means M3 for comparing the time of flight thus measured with a predetermined time of flight TOF,
e. means M4 for unlocking or locking the door 100 according to the result of the comparison.

The device D also comprises a processor 200 and a memory 201 (cf. FIG. 4) that stores instructions allowing the processor to be configured to execute certain particular processing operations, in particular to implement the steps of the locking or unlocking method according to the embodiment described later on.

Said means listed above, the detection means M0, the means for controlling the transmission of high frequency waves M1, the means for measuring the time of flight M2, the comparison means M3, the unlocking/locking means M4, the processor 200 and the memory 201, are in the form of software and are, for example but without being at all limiting in themselves, included in a central control unit 10 (cf. FIG. 4) that is electronically connected to the two transceivers Tx1, Tx2 and to electric unlocking or locking means of the door 100.

In an improvement to an aspect of the invention, the device D also comprises:
a. means M5 for comparing the time of flight with a first threshold Δ1, the device D being capable of controlling unlocking on the basis of the result of said comparison, and
b. means M6 for comparing the time of flight with a second threshold Δ2, the device D being capable of controlling locking on the basis of the result of said comparison.

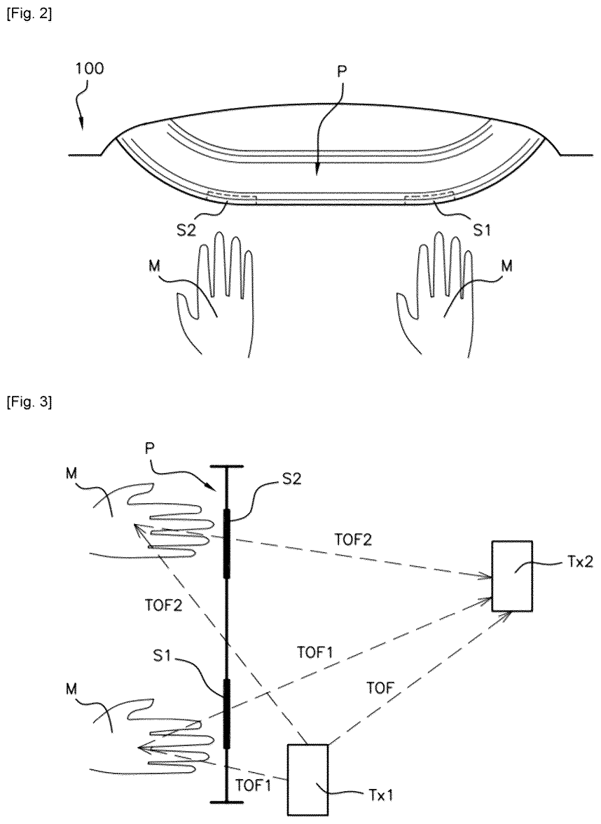

To this end, the handle P of the door 100 comprises two surfaces that are easily identifiable by the user U, for example oriented toward the outside of the vehicle V, an unlocking surface S1 and an unlocking surface S2, which is distinct from the unlocking surface S1 (cf. FIG. 2).

The approach of the hand M of the user U toward the first surface S1 or toward the second surface S2 increases the difference between the measured time of flight TOF1, TOF2 between the two transmitters Tx1, Tx2 and the predetermined time of flight TOF (cf. FIG. 3), and said difference is then greater than the first threshold Δ1 and the second threshold Δ2, respectively.

The predetermined time of flight TOF between the two transceivers Tx1, Tx2 has been previously measured without any hand M close to the handle P, either close to the first surface S1 or close to the second surface S2.

Thus, the approach of the hand M toward the unlocking surface S1, or toward the locking surface S2, modifies the time of flight between the two transceivers Tx1, Tx2 and can thus be used to trigger unlocking or unlocking (cf. FIG. 3).

Of course, there can be only one surface, for activating either unlocking or locking. The approach of the user's hand M toward this single surface increases the time of flight TOF1, TOF2 between the two transceivers Tx1, Tx2 and controls:
a. either locking, if the vehicle was previously unlocked,
b. or unlocking, if the vehicle was previously locked, as described later on.

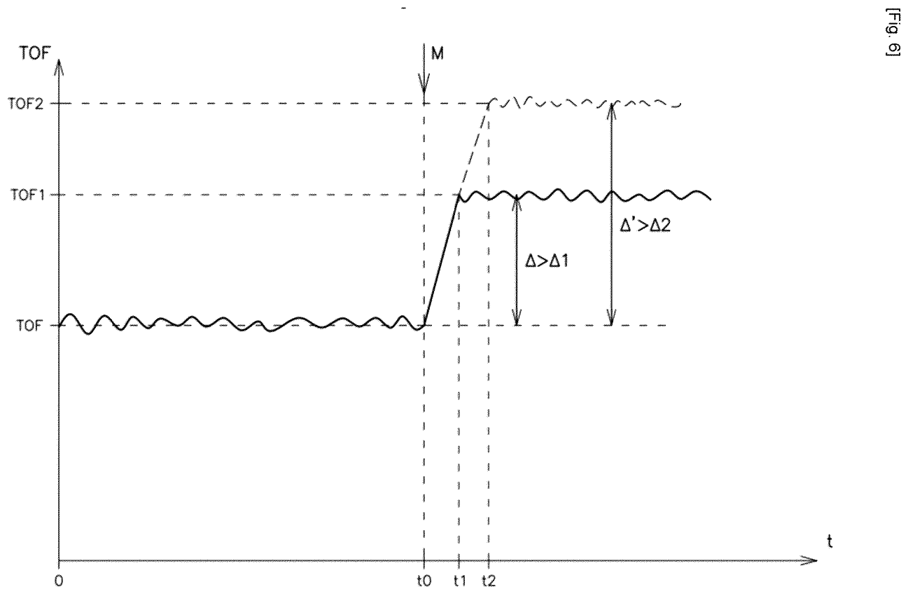

The locking or unlocking method according to an aspect of the invention, illustrated in FIG. 5, will now be described.

In a preliminary step E0, it is detected that the portable user equipment SD is in the predetermined zone Z1 around the vehicle, said zone allowing “hands-free” access to the vehicle V. This detection step is known from the prior art and will not be described in more detail here.

In a first step E1, once the presence of the portable equipment SD has been detected in the predetermined zone Z1, the device D controls the transmission of high frequency waves, for example by ultra-wideband, between the two transceivers Tx1, Tx2. In this instance, either the first transceiver Tx1 transmits waves to the second transceiver Tx2, or vice versa.

Once the waves have been received by either the second transceiver Tx2 or the first Tx1, respectively, the time of flight TOF1, TOF2 of the waves between the two transceivers Tx1, Tx2 is determined (step E2).

Then, during the subsequent steps E3a, E3b, the time of flight TOF1, TOF2 thus determined is compared with a predetermined time of flight TOF.

Said predetermined time of flight TOF has been previously measured between the two transceivers Tx1, Tx2 without any presence of the hand M in the predetermined zone Z1.

If the result of the comparison between the measured time of flight TOF1 and the predetermined time of flight TOF is greater than a first threshold Δ1 (step E3a), this means that the user's hand is approaching the unlocking surface S1 and unlocking DV of the door 100 is triggered (step E4a).

If the result of the comparison between the measured time of flight TOF2 and the predetermined time of flight TOF is greater than a second threshold Δ2 (step E3b), this means that the user's hand M is approaching the locking surface and locking V of the door 100 is triggered (step E4b).

Of course, there can be only one surface S, allowing the door 100 to be both locked and unlocked. This embodiment is illustrated in dotted lines in FIG. 5. In this case, the measured time of flight TOF1 is compared with the predetermined time of flight TOF and if the comparison is above the first threshold Δ1 (step E3a) (which may be of a different value than the first threshold used with the unlocking surface), then either unlocking or locking is activated.

Unlocking is activated (step E4c) if it has been detected that the vehicle V was previously locked (step E3c) and, conversely, locking is activated (step E4d) if it has been detected that the vehicle was previously unlocked (step E3c).

The applicant has noted that the approach of a hand M near the first transceiver Tx1 located in the door significantly and measurably modified the propagation of the high frequency UWB waves between the first and second transceivers Tx1, Tx2. In this instance, the human body has a wave propagation index different than that of air and absorbs and diffracts the waves, thus lengthening their time of flight.

This is illustrated in FIGS. 3 and 6. FIG. 3 shows the time of flight TOF between the two transceivers Tx1, Tx2 without any hand M located close to the handle P, nor in the predetermined zone Z1.

FIG. 3 also shows the times of flight TOF1, TOF2 between the two transceivers Tx1, Tx2, in the presence or on the approach of the hand M of the user U close to the unlocking surface S1 and the locking surface S2, respectively. It is clear that some of the UWB waves are absorbed or diffracted as they pass through and over the human body. This phenomenon affects the time of flight of the waves between the two transceivers Tx1, Tx2 by lengthening it significantly.

FIG. 6 illustrates the time of flight TOF between the two transceivers Tx1, Tx2 according to time t. Up to the time to, the time of flight TOF is equal to the predetermined time of flight TOF, and there is therefore no hand M close to the door 100.

At the time t1, the time of flight TOF increases considerably by a value greater than a first threshold Δ1, to reach the value TOF1, this meaning that the user's hand M is approaching the unlocking surface S1 and therefore that the user U wishes to unlock their vehicle V.

FIG. 6 also illustrates the case where the hand M of the user U approaches the locking surface S2 at the time to. In this case, the time of flight TOF increases considerably by a value greater than a second threshold Δ2, to reach the value TOF2, this meaning that the user's hand M is approaching the locking surface S2 and therefore that they wish to lock their vehicle V.

An aspect of the invention is therefore convenient because it allows the use of high frequency transceivers aboard the vehicle that are intended to identify and locate a portable access equipment around the vehicle to detect the presence of a hand near the door handle and thus to unlock or lock the vehicle V.

An aspect of the invention is particularly ingenious because it gets rid of capacitive sensors and thus their cost and technical drawbacks and uses components that are already aboard the vehicle to make them perform a different function than that for which they were intended.

There is therefore a synergy of means in order to obtain a second technical effect compared to the prior art.

1. A method for locking or unlocking a door of a vehicle, using a locking/unlocking device aboard the vehicle, comprising at least two high frequency communication transceivers capable of communicating with a portable user equipment, of which a first transceiver is located in the door and a second transceiver is located inside the vehicle, the method comprising:
a) detecting the presence of the portable user equipment in a predetermined zone around the vehicle,
b) if a portable equipment has been detected, transmitting waves between the two transceivers,
c) measuring a time of flight of said waves,
d) comparing said measured time of flight with a predetermined time of flight previously measured without any hand close to the handle,
e) unlocking or locking the door if a result of the comparison is greater than a first threshold, an approach by the user's hand modifying the propagation of waves between the first and the second receiver and increasing the time of flight.

2. The unlocking or locking method as claimed in claim 1, wherein the door is previously equipped with two surfaces that are identifiable by the user, an unlocking surface and a locking surface, and:
a) when the user approaches the unlocking surface, the time of flight is greater than a time of flight previously measured without a hand and unlocking is activated
b) when the user approaches the locking surface, the time of flight is greater than a time of flight previously measured without a hand and locking is activated.

3. The unlocking or locking method as claimed in claim 2, wherein if the time of flight is greater than the first threshold then unlocking is activated, and if the time of flight is greater than the second threshold then locking is activated.

4. The unlocking or locking method as claimed in claim 1, wherein the predetermined time of flight has been previously measured in the absence of the portable equipment in the predetermined zone around the vehicle.

5. A device for locking or unlocking a door of a motor vehicle, which device is intended to be aboard said vehicle, comprising at least two high frequency communication transceivers capable of communicating with a portable user equipment, of which a first transceiver is located in the door and a second transceiver is located inside the vehicle, the device being further capable of:
a) detecting the presence of the portable user equipment in a predetermined zone around the vehicle,
b) controlling the transmission of waves between the two transceivers on the basis of the detection,
c) measuring a time of flight of said waves,
d) comparing said measured time of flight with a predetermined time of flight,
e) unlocking or locking the door according to the result of the comparison.

6. The locking or unlocking device as claimed in claim 5, further comprising two surfaces on the door that are identifiable by the user, an unlocking surface and a locking surface.

7. The locking or unlocking device as claimed in claim 6, further comprising:
a) means for comparing the time of flight with a first threshold, and
b) means for comparing the time of flight with a second threshold, and in that it is capable of unlocking the door on the basis of a result of comparison with the first threshold and of locking the door on the basis of a result of comparison with the second threshold.

8. A non-transitory computer program product comprising program code instructions for executing the steps of the method as claimed in claim 1 when said program is executed on a computer.

9. A motor vehicle, comprising a locking or unlocking device as claimed in claim 5.
